(19) United States
(12) Patent Application Publication
(10) Pub. No.: US 2007/0132954 A1
(43) Pub. Date: Jun. 14, 2007

(54) PROJECTOR AND OPTICAL PART

(75) Inventors: Hiroaki YANAI, Suwa-shi, Nagano-ken (JP); Toshiaki HASHIZUME, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/608,372

(22) Filed: Dec. 8, 2006

(30) Foreign Application Priority Data
Dec. 13, 2005 (JP) 2005-358585

(51) Int. Cl. G03B 21/14

(52) U.S. Cl. 353/20

(57) ABSTRACT

A projector includes an optical element, and a polarizing plate that is bonded to the optical element through an adhesive layer. The polarizing plate has a polarizing layer, and a support layer that is disposed on the polarizing layer close to the optical element so as to support the polarizing layer. A cured coating layer is formed at a surface of the polarizing plate facing the optical element.

### BACKGROUND

1. Technical Field

The present invention relates to a projector and an optical part.

2. Related Art

There is a known projector that includes three liquid crystal panels modulating three color light components according to image information, a cross dichroic prism synthesizing the color light components modulated by the three liquid crystal panels, three light-incident-side polarizing plate disposed on light incident sides of the individual liquid crystal panels so as to serve as a polarizer, and three light-emergent-side polarizing plates disposed on light emergent sides of the individual liquid crystal panels so as to serve as an analyzer (for example, see JP-A-1-267587). In addition, the light-emergent-side polarizing plates are respectively attached to light-incident end surfaces of the cross dichroic prism. The light-emergent-side polarizing plates are respectively attached to the light-incident end surfaces of the cross dichroic prism by a pressure sensitive adhesive.

According to the known projector, since the light-emergent-side polarizing plates are respectively attached to the light-incident end surfaces of the cross dichroic prism, heat generated from the light-emergent-side polarizing plates can be dissipated to the cross dichroic prism having a high heat capacity. For this reason, an increase in temperature of the light-emergent-side polarizing plates can be suppressed, and a polarization characteristic can be prevented from being degraded due to thermal deformation of the light-emergent-side polarizing plates (expansion and contraction or distortion). As a result, deterioration of image quality of a projected image can be suppressed.

By the way, when an optical film, such as a light-emergent-side polarizing plate or the like (an optical film other than the light-emergent-side polarizing plate includes, for example, a light-incident-side polarizing plate, a viewing angle compensating plate, and a phase plate), is attached to an optical element, such as a cross dichroic prism or the like (an optical element other than the cross dichroic prism includes, for example, a collective lens, a light-transmissive member, and a polarization separating optical element), a pressure sensitive adhesive or an adhesive is generally used. However, the used of the pressure sensitive adhesive or the adhesive causes the following problems.

For example, like the known projector, when the light-emergent-side polarizing plate is attached to the cross dichroic prism using the pressure sensitive adhesive, bubbles are likely to remain at an interface between a pressure sensitive adhesive layer and the cross dichroic prism. Further, since the pressure sensitive adhesive has a tack strength (adhesive force) lower than the adhesive, the light-emergent-side polarizing plate is likely to be separated from the cross dichroic prism. If the bubbles remain at the interface between the pressure sensitive adhesive layer and the cross dichroic prism, and the light-emergent-side polarizing plate is separated from the cross dichroic prism, the polarization characteristic of the light-emergent-side polarizing plate is degraded, which causes deterioration of image quality of a projected image.

Meanwhile, when the light-emergent-side polarizing plate is attached to the cross dichroic prism using the adhesive, the bubbles rarely remain at the interface between an adhesive layer and the cross dichroic prism, and the light-emergent-side polarizing plate is rarely separated from the cross dichroic prism compared with a case where the pressure sensitive adhesive is used. Accordingly, the above-described problems can be solved.

However, in recent years, with high luminance of the projector, compared with the known projector, a larger amount of heat is generated from the light-emergent-side polarizing plate, and an increase in temperature of the light-emergent-side polarizing plate more easily occurs. Accordingly, compared with the known projector, thermal deformation of the light-emergent-side polarizing plate more easily occurs. As a result, in a case where the adhesive is used, the light-emergent-side polarizing plate may be more easily separated from the cross dichroic prism compared with the known projector.

As the light-emergent-side polarizing plate used in the projector, a three-layered light-emergent-side polarizing plate on which support layers formed of triacetyl cellulose (TAC) are laminated on both surfaces of a polarizing layer formed of polyvinyl alcohol (PVA) in order to secure mechanical strength or the like is generally used. When such a light-emergent-side polarizing plate is attached to the optical element, an adhesive layer is formed at the surface of the support layer in the light-emergent-side polarizing plate, and an adhesive property of the adhesive layer to the support layer is bad in a high temperature environment. Accordingly, compared with the known projector, the light-emergent-side polarizing plate may be more easily separated from the optical element due to an increase in temperature of the light-emergent-side polarizing plate. When the light-emergent-side polarizing plate is separated from the optical element, the polarization characteristic of the light-emergent-side polarizing plate is degraded, which causes deterioration of image quality of a projected image.

The above-described problems appear in the light-incident-side polarizing plate, as well as the light-emergent-side polarizing plate. That is, the above-described problems appear over the polarizing plates.

Further, the above-described problems appear in the viewing angle compensating plate and the phase plate, as well as the polarizing plates.

That is, when the viewing angle compensating plate is attached to the optical element (for example, the cross dichroic prism, the collective lens, or the light-transmissive member) using the adhesive, a adhesive layer is formed at the surface of the viewing angle compensating plate, but a adhesive property of the adhesive layer to the viewing angle compensating plate is bad in a high temperature environment. Accordingly, with high luminance of the projector, the temperature of the viewing angle compensating plate increases, and then the viewing angle compensating plate may be more easily separated from the optical element compared with the known projector. When the viewing angle compensating plate is separated from the optical element, an optical characteristic of the viewing angle compensating plate is degraded, which causes deterioration of image quality of a projected image.

Meanwhile, when the phase plate is attached to the optical element (for example, the polarization separating optical element, the collective lens, or the light-transmissive member) using the adhesive, a adhesive layer is formed at the surface of the phase plate, a adhesive property of the adhesive layer to the phase plate is bad in a high temperature environment. Accordingly, with high luminance of the projector, the temperature of the phase plate increases, and then the phase plate may be more easily separated from the optical element compared with the known projector. When the phase plate is separated from the optical element, an optical characteristic of the phase plate is degraded, which causes deterioration of image quality of a projected image.

### SUMMARY

An advantage of some aspects of the invention is that it provides a projector that can suppress a polarizing plate, a viewing angle compensating plate, or a phase plate from being separated from an optical element due to an increase in temperature of the polarizing plate, the viewing angle compensating plate, or the phase plate when the polarizing plate, the viewing angle compensating plate, or the phase plate is attached to the optical element using an adhesive. Another advantage of some aspects of the invention is that it provides an optical part that can suppress a polarizing plate, a viewing angle compensating plate, or a phase plate from being more easily separated due to an increase in temperature of the polarizing plate, the viewing angle compensating plate, or the phase plate, compared with a known optical part.

In order to achieve the above-described advantages, the inventors have studied a unit that increases a adhesive force between a polarizing plate and an optical element when the polarizing plate is attached to the optical element using an adhesive, then have found that the adhesive force between the polarizing plate and the optical element increases and the polarizing plate is suppressed from being separated from the optical element due to an increase in temperature of the polarizing plate by forming a cured coating layer on a surface of the polarizing plate facing the optical element, and subsequently have completed the invention.

According to a first aspect of the invention, a projector includes an optical element, and a polarizing plate that is bonded to the optical element through an adhesive layer. The polarizing plate has a polarizing layer, and a support layer that is disposed on the polarizing layer close to the optical element so as to support the polarizing layer. A cured coating layer is formed at a surface of the polarizing plate facing the optical element.

With this configuration, since the cured coating layer is formed at the surface of the support layer disposed on the polarizing layer close to the optical element to face the optical element, the adhesive layer is formed at the surface of the cured coating layer, not the surface of the support layer. If the cured coating layer is formed at the surface of the polarizing plate facing the optical element, an adhesive property between the polarizing plate and the optical element increases. Accordingly, the projector according to the first aspect of the invention becomes a projector that can suppress the polarizing plate from being easily separated from the optical element due to an increase in temperature of the polarizing plate compared with the known projector, and therefore becomes a projector that can suppress deterioration of image quality of a projected image.

In the projector according to the first aspect of the invention, the optical element may be a light-transmissive substrate, a cross dichroic prism, a polarization separating prism, or a lens.

In the projector according to the first aspect of the invention, the optical element may be formed of sapphire or quartz. Further, the optical element may be formed of vitreous silica, borosilicate glass, or other light-transmissive glass, or may be formed of crystallized glass.

When the optical element is formed of sapphire or quartz, since this material exhibits excellent thermal conductivity, heat generated from the polarizing plate can be efficiently dissipated outside the system, and an increase in temperature of the polarizing plate can be effectively suppressed. Further, since the above-described material has a small thermal expansion coefficient, when the polarizing plate having large expansion or deformation due to heat is bonded to the optical element formed of such a material having a small thermal expansion coefficient, the deformation of the polarizing plate can be suppressed.

When the optical element is formed of vitreous silica, borosilicate glass or other light-transmissive glass, since this material has a small birefringence, deterioration of image of a light flux passing through the optical element can be suppressed, and deterioration of quality of a light flux incident on the polarizing plate or a light flux emitted from the polarizing plate can be suppressed. Further, since the above-described material has a comparatively small thermal expansion coefficient, when the polarizing plate having large expansion or deformation due to heat is bonded to the optical element formed of such a material having a small thermal expansion coefficient the deformation of the polarizing plate can be suppressed.

When the optical element is formed of crystallized glass, when an axial direction where thermal expansion of crystallized glass is large and an extension direction of the polarizing plate are arranged, the thermal deformation of the polarizing plate can be suppressed.

The projector according to the first aspect of the invention may further include an additional optical element that is disposed at an opposite side of the polarizing plate from the optical element and is bonded to the polarizing plate through an adhesive layer.

With this configuration, since heat generated from the polarizing plate can be transferred to the additional optical element, an increase in temperature of the polarizing plate can be suppressed. For this reason, occurrence of thermal deformation of the polarizing plate can be further suppressed, and the polarizing plate can be suppressed from being easily separated from the optical element due to the increase in temperature of the polarizing plate.

In the projector according to the first aspect of the invention, the additional optical element may be a light-transmissive substrate.

In the projector according to the first aspect of the invention, the additional optical element may be formed of sapphire or quartz. Further, the additional optical element may be formed of vitreous silica, borosilicate glass, or other light-transmissive glass, or may be formed of crystallized glass.

When the additional optical element is formed of sapphire or quartz, since this material exhibits excellent thermal conductivity, heat generated from the polarizing plate can be efficiently dissipated outside the system, and an increase in temperature of the polarizing plate can be effectively suppressed. Further, since the above-described material has a small thermal expansion coefficient, when the polarizing plate having large expansion or deformation due to heat is bonded to the additional optical element formed of such a material having a small thermal expansion coefficient, the deformation of the polarizing plate can be suppressed.

When the additional optical element is formed of vitreous silica, borosilicate glass or other light-transmissive glass, since this material has a small birefringence, deterioration of image of a light flux passing through the additional optical element can be suppressed, and deterioration of quality of a light flux incident on the polarizing plate or a light flux emitted from the polarizing plate can be suppressed. Further, since the above-described material has a comparatively small thermal expansion coefficient, when the polarizing plate having large expansion or deformation due to heat is bonded to the additional optical element formed of such a material having a small thermal expansion coefficient the deformation of the polarizing plate can be suppressed.

When the additional optical element is formed of crystallized glass, when an axial direction where thermal expansion of crystallized glass is large and an extension direction of the polarizing plate are arranged, the thermal deformation of the polarizing plate can be suppressed.

In the projector according to the first aspect of the invention, the polarizing plate further may have an additional support layer that is disposed on the polarizing layer close to the additional optical element so as to support the polarizing layer, and a cured coating layer may be formed at a surface of the polarizing plate facing the additional optical element.

As such, if the cured coating layer is formed at the surface of the polarizing plate facing the additional optical element, a adhesive property between the polarizing plate and the additional optical element increases, and thus the polarizing plate can be suppressed from being easily separated from the additional optical element due to the increase in temperature of the polarizing plate. As a result, deterioration of image quality of a projected image can be further suppressed.

Further, the inventors have studied a unit that increases a adhesive force between a viewing angle compensating plate and an optical element when the viewing angle compensating plate is attached to the optical element using an adhesive, then have found that the adhesive force between the viewing angle compensating plate and the optical element increases and the viewing angle compensating plate is suppressed from being separated from the optical element due to an increase in temperature of the viewing angle compensating plate by forming a cured coating layer on a surface of the viewing angle compensating plate facing the optical element, and subsequently have completed the invention.

According to a second aspect of the invention, a projector includes an optical element, and a viewing angle compensating plate that is bonded to the optical element through an adhesive layer. A cured coating layer is formed at a surface of the viewing angle compensating plate facing the optical element.

With this configuration, since the cured coating layer is formed at the surface of the viewing angle compensating plate facing the optical element, the adhesive layer is formed at the surface of the cured coating layer, not the surface of the viewing angle compensating plate. When the cured coating layer is formed at the surface of the viewing angle compensating plate facing the optical element, an adhesive property between the viewing angle compensating plate and the optical element increases. Accordingly, the projector according to the second aspect of the invention becomes a projector that can suppress the viewing angle compensating plate from being easily separated from the optical element due to an increase in temperature of the viewing angle compensating plate compared with the known projector, and therefore becomes a projector that can suppress deterioration of image quality of a projected image.

In the projector according to the second aspect of the invention, the optical element may be a light-transmissive substrate, a cross dichroic prism, or a lens.

In the projector according to the second aspect of the invention, the optical element may be formed of sapphire or quartz. Further, the optical element may be formed of vitreous silica, borosilicate glass, or other light-transmissive glass.

When the optical element is formed of sapphire or quartz, since this material exhibits excellent thermal conductivity, heat generated from the viewing angle compensating plate can be efficiently dissipated outside the system, and an increase in temperature of the viewing angle compensating plate can be effectively suppressed. Further, since the above-described material has a small thermal expansion coefficient, when the viewing angle compensating plate having large expansion or deformation due to heat is bonded to the optical element formed of such a material having a small thermal expansion coefficient, deformation of the viewing angle compensating plate can be suppressed.

When the optical element is formed of vitreous silica, borosilicate glass or other light-transmissive glass, since this material has a small birefringence, deterioration of image of a light flux passing through the optical element can be suppressed, and deterioration of quality of a light flux incident on the viewing angle compensating plate or a light flux emitted from the viewing angle compensating plate can be suppressed. Further, since the above-described material has a comparatively small thermal expansion coefficient, when the viewing angle compensating plate having large expansion or deformation due to heat is bonded to the optical element formed of such a material having a small thermal expansion coefficient the deformation of the viewing angle compensating plate can be suppressed.

In addition, the inventors have studied a unit that increases a adhesive force between a phase plate and an optical element when the phase plate is attached to the optical element using an adhesive, then have found that the adhesive force between the phase plate and the optical element increases and the phase plate is suppressed from being separated from the optical element due to an increase in temperature of the phase plate by forming a cured coating layer on a surface of the phase plate facing the optical element, and subsequently have completed the invention.

According to a third aspect of the invention, a projector includes an optical element, and a phase plate that is bonded to the optical element through an adhesive layer. A cured coating layer is formed at a surface of the phase plate facing the optical element.

With this configuration, since the cured coating layer is formed at the surface of the phase plate facing the optical element, the adhesive layer is formed at the surface of the cured coating layer, not the surface of the phase plate. When the cured coating layer is formed at the surface of the phase plate facing the optical element, an adhesive property between the phase plate and the optical element increases. Accordingly, the projector according to the second aspect of the invention becomes a projector that can suppress the phase plate from being easily separated from the optical element due to an increase in temperature of the phase plate compared with the known projector, and therefore becomes a projector that can suppress deterioration of image quality of a projected image.

In the projector according to the third aspect of the invention, the optical element may be a polarization separating prism in a polarization conversion element, a light-transmissive substrate, or a lens.

In the projector according to the third aspect of the invention, the optical element may be formed of sapphire or quartz. Further, the optical element may be formed of vitreous silica, borosilicate glass, or other light-transmissive glass.

When the optical element is formed of sapphire or quartz, since this material exhibits excellent thermal conductivity, heat generated from the phase plate can be efficiently dissipated outside the system, and an increase in temperature of the phase plate can be effectively suppressed. Further, since the above-described material has a small thermal expansion coefficient, when the phase plate having large expansion or deformation due to heat is bonded to the optical element formed of such a material having a small thermal expansion coefficient, deformation of the phase plate can be suppressed.

When the optical element is formed of vitreous silica, borosilicate glass or other light-transmissive glass, since this material has a small birefringence, deterioration of image of a light flux passing through the optical element can be suppressed, and deterioration of quality of a light flux incident on the phase plate or a light flux emitted from the phase plate can be suppressed. Further, since the above-described material has a comparatively small thermal expansion coefficient, when the phase plate having large expansion or deformation due to heat is bonded to the optical element formed of such a material having a small thermal expansion coefficient the deformation of the phase plate can be suppressed.

In the projector according to any one of the aspects of the invention, the adhesive layer may be formed of an acryl-based adhesive, a silicon-based adhesive, or an epoxy-based adhesive.

In the projector according to any one of the aspects of the invention, the cured coating layer may be formed of acryl-based resin, silicon-based resin, melamine-based resin, urethane-based resin, or epoxy-based resin.

In this case, the adhesive layer and the cured coating layer are preferably formed of the same kind of resin material. Accordingly, since it is possible to further increase the adhesive force between the polarizing plate, the viewing angle compensating plate, or the phase plate and the optical element, the polarizing plate, the viewing angle compensating plate, or the phase plate can be further suppressed from being separated from the optical element due to the increase in temperature of the polarizing plate, the viewing angle compensating plate, or the phase plate. Further, reflection of light at an interface between the cured coating layer and the adhesive layer can be suppressed, and thus a loss of a light amount due to such undesirable reflection can be reduced.

In the projector according to any one of the aspects of the invention, as the adhesive layer, an ultraviolet curable adhesive or a short wavelength visible light curable adhesive can be suitably used.

According to a fourth aspect of the invention, an optical part includes an optical element, and a polarizing plate that is attached to the optical element through an adhesive layer. The polarizing plate has a polarizing layer, and a support layer that is disposed on the polarizing layer close to the optical element so as to support the polarizing layer. A cured coating layer is formed at a surface of the polarizing plate facing the optical element.

With this configuration, since the cured coating layer is formed at the surface of the support layer disposed on the polarizing plate close to the optical element to face the optical element, the adhesive layer is formed at the surface of the cured coating layer, not the surface of the support layer. Like the projector according to the first aspect of the invention, when the cured coating layer is formed at the surface of the polarizing plate facing the optical element, a adhesive property between the polarizing plate and the optical element increases. Accordingly, the optical part according to the fourth aspect of the invention becomes an optical part that can suppress the polarizing plate from being easily separated from the optical element due to an increase in temperature of the polarizing plate compared with the known optical part.

According to a fifth aspect of the invention, an optical part includes an optical element, and a viewing angle compensating plate that is attached to the optical element through an adhesive layer. A cured coating layer is formed at a surface of the viewing angle compensating plate facing the optical element.

With this configuration, since the cured coating layer is formed at the surface of the viewing angle compensating plate facing the optical element, the adhesive layer is formed at the surface of the cured coating layer, not the surface of the viewing angle compensating plate. Like the projector according to the second aspect of the invention, if the cured coating layer is formed at the surface of the viewing angle compensating plate facing the optical element, an adhesive property between the viewing angle compensating plate and the optical element increases. Accordingly, the optical part according to the fifth aspect of the invention becomes an optical part that can suppress the viewing angle compensating plate from being easily separated from the optical element due to an increase in temperature of the viewing angle compensating plate compared with the known optical part.

According to a sixth aspect of the invention, an optical part includes an optical element, and a phase plate that is attached to the optical element through an adhesive layer. A cured coating layer is formed at a surface of the phase plate facing the optical element.

With this configuration, since the cured coating layer is formed at the surface of the phase plate facing the optical element, the adhesive layer is formed at the surface of the cured coating layer, not the surface of the phase plate. Like the projector according to the third aspect of the invention, if the cured coating layer is formed at the surface of the phase plate facing the optical element, an adhesive property between the phase plate and the optical element increases. Accordingly, the optical part according to the sixth aspect of the invention becomes an optical part that can suppress the phase plate from being easily separated from the optical element due to an increase in temperature of the phase plate compared with the known optical part.

### BRIEF DESCRIPTION OF THE DRAWINGS

The invention will be described with reference to the accompanying drawings, wherein like numbers reference like elements.

FIG. 1 is a diagram showing an optical system of a projector 1000 according to a first embodiment of the invention.

FIG. 2A is a diagram illustrating main parts of the projector 1000 according to the first embodiment of the invention.

FIG. 2B is a diagram illustrating main parts of the projector 1000 according to the first embodiment of the invention.

FIG. 3A is a diagram illustrating main parts of the projector 1000 according to the first embodiment of the invention.

FIG. 3B is a diagram illustrating main parts of the projector 1000 according to the first embodiment of the invention.

FIG. 4A is a diagram illustrating main parts of the projector 1000 according to the first embodiment of the invention.

FIG. 4B is a diagram illustrating main parts of the projector 1000 according to the first embodiment of the invention.

FIG. 5A is a diagram illustrating main parts of a projector 1002 according to a second embodiment of the invention.

FIG. 5B is a diagram illustrating main parts of the projector 1002 according to the second embodiment of the invention.

FIG. 6A is a diagram illustrating main parts of the projector 1002 according to the second embodiment of the invention.

FIG. 6B is a diagram illustrating main parts of the projector 1002 according to the second embodiment of the invention.

FIG. 7A is a diagram illustrating main parts of a projector 1004 according to a third embodiment of the invention.

FIG. 7B is a diagram illustrating main parts of the projector 1004 according to the third embodiment of the invention.

FIG. 8A is a diagram illustrating main parts of a projector 1006 according to a fourth embodiment of the invention.

FIG. 8B is a diagram illustrating main parts of the projector 1006 according to the fourth embodiment of the invention.

FIG. 9 is a diagram of the periphery of a light-emergent-side polarizing plate 430R as viewed from the side.

FIG. 10A is a diagram illustrating main parts of a projector 1008 according to a fifth embodiment of the invention.

FIG. 10B is a diagram illustrating main parts of the projector 1008 according to the fifth embodiment of the invention.

FIG. 11A is a diagram illustrating main parts of a projector 1010 according to a sixth embodiment of the invention.

FIG. 11B is a diagram illustrating main parts of the projector 1010 according to the sixth embodiment of the invention.

### DESCRIPTION OF EXEMPLARY EMBODIMENTS

Hereinafter, a projector and an optical part according to the invention will be described by way of embodiments with reference to the drawings.

### First Embodiment

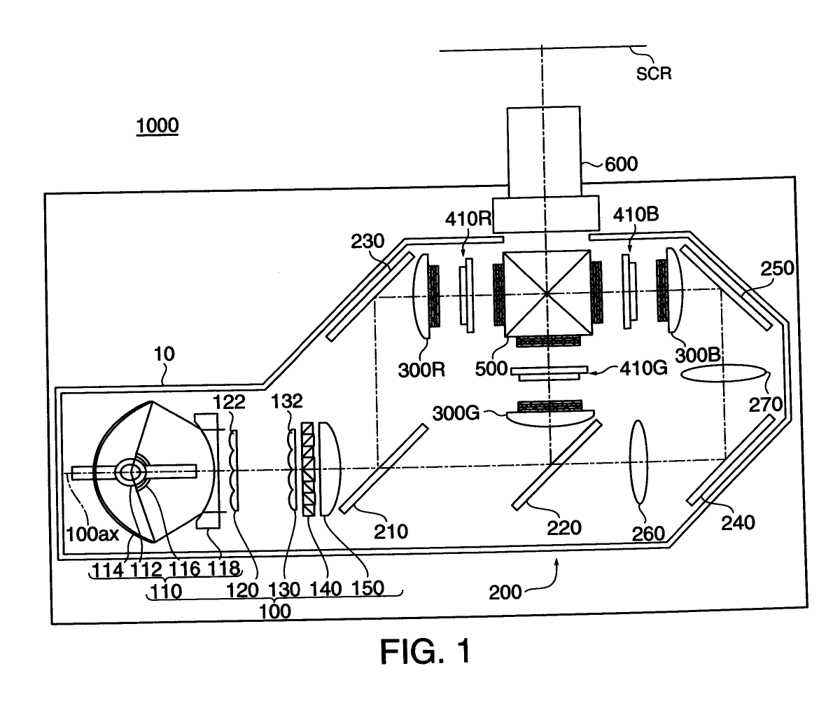

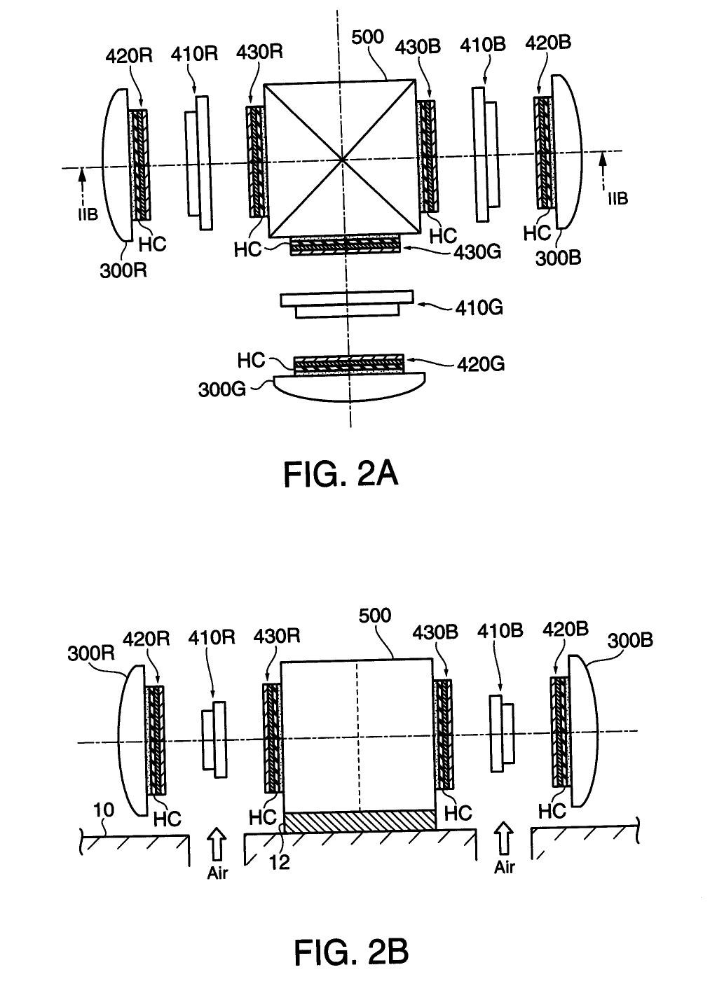

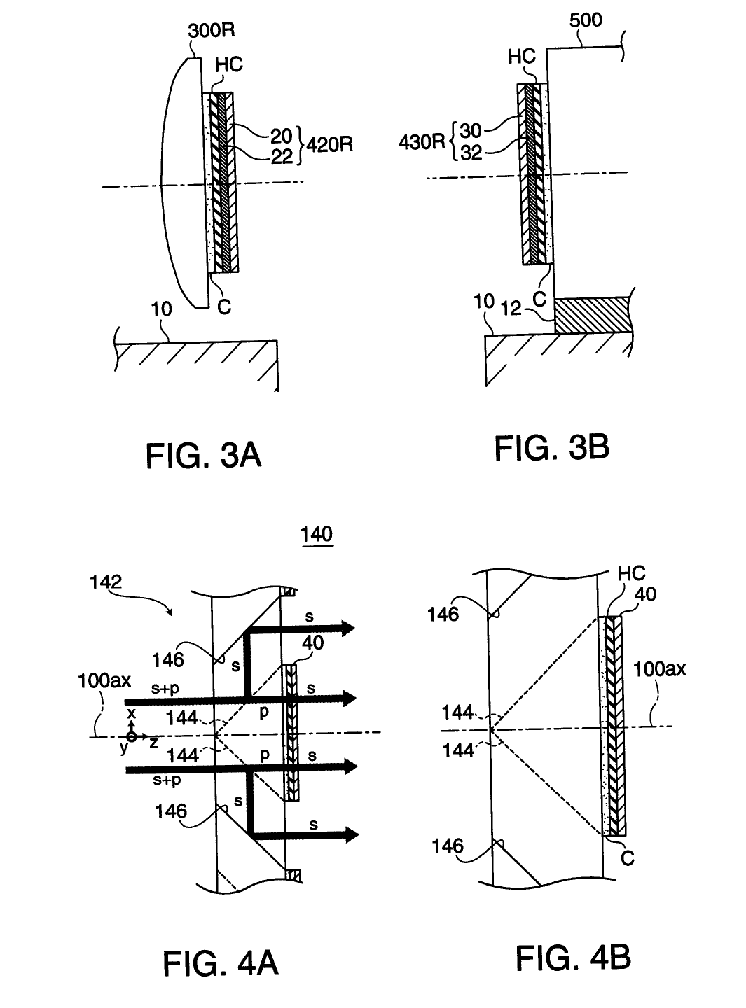

FIG. 1 is a diagram showing an optical system of a projector 1000 according to a first embodiment of the invention. FIGS. 2A to 4B are diagrams illustrating main parts of the projector 1000 according to the first embodiment of the invention. Specifically, FIG. 2A is a diagram of the periphery of a cross dichroic prism 500 as viewed from the top. FIG. 2B is a cross-sectional view taken along the line IIB-IIB. FIG. 3A is a diagram of the periphery of a light-incident-side polarizing plate 420R as viewed from the side. FIG. 3B is a diagram of the periphery of a light-emergent-side polarizing plate 430R as viewed from the side. FIG. 4A is a diagram illustrating a function of a polarization conversion element 140. FIG. 4B is an enlarged view showing main parts of FIG. 4A.

Moreover, in the following description, three directions that are perpendicular to one another are referred to as a z-axis direction (in FIG. 1, a direction of an illumination light axis 100ax), an x-axis direction (in FIG. 1, a direction parallel to the paper and orthogonal to the z axis), and a y-axis direction (in FIG. 1, a direction orthogonal to the paper and orthogonal to the z axis), respectively.

As shown in FIG. 1, a projector 1000 according to the first embodiment of the invention includes an illumination device 100, a color separating and guiding optical system 200 that separates an illumination light flux from the illumination device 100 into three color light components of red, green, and blue and guides the separated color light components to regions to be illuminated, three liquid crystal panels 410R, 410G, and 410B that respectively modulate the three color light components separated by the color separating and guiding optical system 200 according to image information, a cross dichroic prism 500 that synthesizes the individual color light components modulated by the three liquid crystal panels 410R, 410G, and 410B, and a projecting optical system 600 that projects light synthesized by the cross dichroic prism 500 onto a projection surface, such as a screen SCR or the like. These optical systems are accommodated in a casing 10.

The illumination device 100 has a light source device 110 that serves as a light source emitting a substantially parallel illumination light flux to the regions to be illuminated, a first lens array 120 that has a plurality of first small lenses 122 dividing the illumination light flux emitted from the light source device 110 into a plurality of partial light fluxes, a second lens array 130 that has a plurality of second small lenses 132 corresponding to the plurality of first small lenses 122 of the first lens array 120, a polarization conversion element 140 that arranges the illumination light flux having an ununiform polarization direction emitted from the light source device 110 into one-type linear polarized light, and a superposing optical system 150 that superposes the individual partial light fluxes emitted from the polarization conversion element 140 on the regions to be illuminated.

The light source device 110 has an ellipsoidal reflector 114, a light-emitting tube 112 that has a light emission center in the vicinity of a first focus of the ellipsoidal reflector 114, an auxiliary mirror 116 that has a reflecting surface facing a reflecting surface of the ellipsoidal reflector 114, and a concave lens 118 that converts condensed light reflected by the ellipsoidal reflector 114 into substantially parallel light and emits converted light toward the first lens array 120. The light source device 110 emits a light flux having the illumination light axis 100ax as a center axis.

The light-emitting tube 112 has a tube sphere portion and a pair of sealing portions that extend to both sides of the tube sphere portion.

The ellipsoidal reflector 114 has a cylindrical neck portion that is inserted and fixed to one sealing portion of the light-emitting tube 112, and a concave reflecting surface that reflects light emitted from the light-emitting tube 112 toward a second focal point.

The auxiliary mirror 116 is provided to face the ellipsoidal reflector 114 with the tube sphere portion of the light-emitting tube 112 interposed therebetween, and returns light components, which do not go toward the ellipsoidal reflector 114, among the light components emitted from the light-emitting tube 112 to the light-emitting tube 112 to be incident on the ellipsoidal reflector 114.

The concave lens 118 is disposed close to the regions to be illuminated of the ellipsoidal reflector 114 so as to emit light from the ellipsoidal reflector 114 toward the first lens array 120.

The first lens array 120 functions as a light flux dividing optical element dividing light from the concave lens 118 into a plurality of partial light fluxes. The first lens array 120 has a plurality of first small lenses 122 that are arranged in a matrix shape in a plane orthogonal to the illumination light axis 100ax.

The second lens array 130 is an optical element that condenses the plurality of partial light fluxes divided by the first lens array 120. Like the first lens array 120, the second lens array 130 has a plurality of second small lenses 132 that are arranged in a matrix shape in a plane orthogonal to the illumination light axis 100ax.

The polarization conversion element 140 is a polarization conversion element that arranges the polarization directions of the partial light fluxes divided by the first lens array 120 and emits the partial light fluxes as one-type linear polarized light.

As shown in FIG. 4A, the polarization conversion element 140 has a polarization separating prism 142 that divides the partial light fluxes divided by the first lens array 120 into illumination light fluxes according to one linear polarized light component (p polarized light component) and illumination light fluxes according to the other linear polarized light component, and a phase plate 40 that is boned to a portion of a light emergent surface of the polarization separating prism 142 through a adhesive layer C.

The polarization separating prism 142 has a polarization separating layer 144 that transmits the illumination light flux according to one linear polarized light component (p polarized light component) of the polarized light components included in the individual partial light fluxes from the first lens array 120 and reflects the illumination light flux according to the other linear polarized light component (s polarized light component), and a reflecting layer 146 that reflects the illumination light flux according to the other linear polarized light component (s polarized light component) reflected by the polarization separating prism 142 in a direction substantially parallel to the illumination light axis 100ax.

The phase plate 40 is disposed in a portion where the illumination light flux according to one linear polarized light component (p polarized light component) passing through the polarization separating layer 144.

The superposing optical system 150 is an optical element that condenses a plurality of partial light fluxes passing through the first lens array 120, the second lens array 130, and the polarization conversion element 140 so as to be superposed on the vicinities of image forming regions of the liquid crystal panels 410R, 410G, and 410B. Moreover, although the superposing optical system 150 shown in FIG. 1 has one lens, it may have a composite lens formed by combining a plurality of lenses.

The color separating and guiding optical system 200 has a first dichroic mirror 210 and a second dichroic mirror 220, reflecting mirrors 230, 240, and 250, a light-incident-side lens 260, and a relay lens 270. The color separating and guiding optical system 200 has a function of separating the illumination light flux emitted from the superposing optical system 150 into three color light components of red, green, and blue, and guiding the individual color light components to the three liquid crystal panels 410R, 410G, and 410B to be illuminated.

The first dichroic mirror 210 and the second dichroic mirror 220 are optical elements in which a wavelength selection film reflecting a light flux of a predetermined wavelength region and transmitting a light flux of a different wavelength region is formed on a substrate. The first dichroic mirror 210 is a mirror that reflects the red light component and transmits other light components. The second dichroic mirror 220 is a mirror that reflects the green light component and transmits the blue light component.

The red light component reflected by the first dichroic mirror 210 is bent by the reflecting mirror 230, and then is incident on the image forming region of the liquid crystal panel 410R for red light through a collective lens 300R.

The collective lens 300R is provided to convert the partial light fluxes from the superposing optical system 150 into light fluxes substantially parallel to main light beams. The collective lens 300R is held by a thermally conductive holding member (not shown), and is provided in the casing 10 through the thermally conductive holding member. Collective lenses 300G and 300B that are disposed in front of optical paths of the liquid crystal panels 410G and 410B also have the same configuration as the collective lens 300R.

The green light component of the green and blue light components passing through the first dichroic mirror 210 is reflected by the second dichroic mirror 220, then passes through the collective lens 300G, and subsequently is incident on the image forming region of the liquid crystal panel 410G for green light. Meanwhile, the blue light component passes through the second dichroic mirror 220, and then passes through the light-incident-side lens 260, the light-incident-side reflecting mirror 240, the relay lens 270, the light-emergent-side reflecting mirror 250, and the collective lens 300B, and subsequently is incident on the image forming region of the liquid crystal panel 400B for blue light. The light-incident-side lens 260, the relay lens 270, and the reflecting mirrors 240 and 250 has a function of guiding the blue light component passing through the second dichroic mirror 220 to the liquid crystal panel 410B.

The light-incident-side lens 260, the relay lens 270, and the reflecting mirrors 240 and 250 are provided in the optical path of blue light. This is to prevent utilization efficiency from being degraded due to light divergence or the like since the length of the optical path of blue light is longer than the length of the optical path of other color light. In the projector 1000 according to the first embodiment of the invention, since the length of the optical path of blue light is longer, the above-described configuration is adopted. Alternatively, the length of the optical path of red light may be longer, and the light-incident-side lens 260, the relay lens 270, and the reflecting mirrors 240 and 250 may be used in the optical path of red light.

The liquid crystal panels 410R, 410G, and 410B modulate the illumination light fluxes according to the image information so as to form a color image, and are illuminated by the light source device 110.

Each of the liquid crystal panels 410R, 410G, and 410B is formed by filling liquid crystal as an electro-optical material between a pair of light-transmissive glass substrates. For example, the liquid crystal panels 410R, 410G, and 410B have a polysilicon TFT as a switching element, and modulate the polarization direction of one-type linear polarized light emitted from light-incident-side polarizing plates 420R, 420G, and 420B according to a given image signal. The liquid crystal panels 410R, 410G, and 410B are held in a liquid panel holding frame formed of an aluminum-based die cast frame (not shown).

The light-incident-side polarizing plates 420R, 420G, and 420B are respectively disposed between the collective lenses 300R, 300G, and 300B and the liquid crystal panels 410R, 410G, and 410B. The light-incident-side polarizing plates 420R, 420G, and 420B have a function of transmitting only linear polarized light components having an axis of a predetermined direction among light components emitted from the collective lenses 300R, 300G, and 300B, and absorbing other light components.

As shown in FIG. 3A, the light-incident-side polarizing plate 420R has a polarizing layer 20 and a support layer 22 that supports the polarizing layer 20.

Then, the light-incident-side polarizing plate 420R is bonded to the light emergent surface of the collective lens 300R through a adhesive layer C such that the support layer 22 is disposed on the polarizing layer 20 close to the collective lens 300R. A cured coating layer HC is formed at a surface of the support layer 22 where the polarizing layer 20 is not disposed (a surface facing the collective lens 300R) through deposition or the like. Moreover, a reflection preventing layer (not shown) is formed at a surface of the polarizing layer 20 where the support layer 22 is not disposed (a surface facing the liquid crystal panel 410R). As the polarizing layer 20, a polarizing layer that is formed by dyeing polyvinyl alcohol (PVA) with iodine or a dichroic dye, uniaxially stretching, and arranging molecules of the dye in one direction may be preferably used. The polarizing layer formed in such a manner absorbs polarized light in a direction parallel to the uniaxial stretch direction, and transmits polarized light in a direction orthogonal to the uniaxial stretch direction. Since the polarizing layer has a large force that returns the stretch state to the original state, in order to regulate this force, the support layer that supports the polarizing layer is provided. As the support layer 22, a support layer formed of triacetyl cellulose (TAC) may be preferably used. The light-incident-side polarizing plates 420G and 420B have the same configuration as the light-incident-side polarizing plate 420R.

The light-emergent-side polarizing plates 430R, 430G, and 430B are respectively disposed between the liquid crystal panels 410R, 410G, and 410B and the cross dichroic prism 500. The light-emergent-side polarizing plates 430R, 430G, and 430B have a function of transmitting only linear polarized light components having an axis of a predetermined direction among the light components emitted from the liquid crystal panels 410R, 410G, and 410B, and absorbing other light components.

As shown in FIG. 3B, the light-emergent-side polarizing plate 430R has a polarizing layer 30 and a support layer 32 that supports the polarizing layer 30. Then, the light-emergent-side polarizing plate 430R is bonded to a light incident end surface of the cross dichroic prism 500 through a adhesive layer C such that the support layer 32 is disposed on the polarizing layer 30 close to the cross dichroic prism 500. A cured coating layer HC is formed at a surface of the support layer 32 where the polarizing layer 30 is not disposed (a surface facing the cross dichroic prism 500) through deposition or the like. Moreover, a reflection preventing layer (not shown) is formed at a surface of the polarizing layer 30 where the support layer 32 is not disposed (a surface facing the liquid crystal panel 410R). As the polarizing layer 30 and the support layer 32, the same materials as those of the light-incident-side polarizing plates 420R, 420G, and 420B may be used. The other light-emergent-side polarizing plates 430G and 430B have the same configuration as the light-emergent-side polarizing plate 430R.

The light-incident-side polarizing plates 420R, 420G, and 420B and the light-emergent-side polarizing plates 430R, 430G, and 430B are set and disposed such that the polarization axes thereof are perpendicular to each other.

The cross dichroic prism 500 is an optical element that synthesizes optical images modulated for the color light components emitted from the individual liquid crystal panels 410R, 410G, and 410B so as to form a color image. The cross dichroic prism 500 has three light incident end surfaces on which the color light components modulated by the liquid crystal panels 410R, 410G, and 410B, and a light emergent end surface from which synthesized color light is emitted. The cross dichroic prism 500 substantially has a square shape formed by combining four right prisms in plan view, and a multilayer dielectric film is formed at a substantially X-shaped interface formed by combining the right prism with each other. A multilayer dielectric film that is formed at one X-shaped interface reflects red light, and a multilayer dielectric film that is formed at the other interface reflects blue light. With the multilayer dielectric films, red light and blue light are bent and are arranged along the travel direction of green light, such that three color light components are synthesized.

The cross dichroic prism 500 is provided in the casing 10 through a thermally conductive spacer 12 (see FIG. 2B).

The color image emitted from the cross dichroic prism 500 is projected by the projecting optical system 600 on a magnified scale, and forms a large screen image on the screen SCR.

The effects of the projector 1000 according to the first embodiment of the invention having the above-described configuration will now be described. Hereinafter, for simple explanation, the effects of the projector 1000 according to the first embodiment of the invention will be described on the basis of the members disposed in the optical path of a red light component among the optical paths of three color light components.

As shown in FIG. 3A, in the projector 1000 according to the first embodiment of the invention, the cured coating layer HC is formed at the surface of the light-incident-side polarizing plate 420R facing the collective lens 300R. That is, the cured coating layer HC is formed at the surface of the support layer 22 close to the collective lens 300R.

In the projector 1000 according to the first embodiment of the invention, since the cured coating layer HC is formed at the surface of the support layer 22 facing the collective lens 300R, and the adhesive layer C is formed at the surface of the cured coating layer HC, not the surface of the support layer 22. If the cured coating layer HC is formed at the surface of the light-incident-side polarizing plate 420R facing the collective lens 300R, a adhesive property between the light-incident-side polarizing plate 420R and the collective lens 300R increases. Accordingly, the projector 1000 according to the first embodiment of the invention becomes a projector that can suppress the light-incident-side polarizing plate 420R from being easily separated from the collective lens 300R due to an increase in temperature of the light-incident-side polarizing plate 420R compared with the known projector, and therefore becomes a projector that can suppress deterioration of image quality of a projected image.

In the projector 1000 according to the first embodiment of the invention, the collective lens 300R is formed of vitreous silica, borosilicate glass, or other light-transmissive glass. Since this material has a small birefringence, degradation of quality of a light flux passing through the collective lens 300R can be suppressed, and degradation of quality of a light flux incident on the light-incident-side polarizing plate 420R can be suppressed. Further, since the above-described material has a comparatively small thermal expansion coefficient, when the light-incident-side polarizing plate 420R having large expansion or deformation due to heat is bonded to the collective lens 300R formed of such a material having a small thermal expansion coefficient, deformation of the light-incident-side polarizing plate 420R can be suppressed.

In the projector 1000 according to the first embodiment of the invention, as shown in FIG. 3B, the cured coating layer HC is formed at the surface of the light-emergent-side polarizing plate 43OR facing the cross dichroic prism 500. That is, the cured coating layer HC is formed at the surface of the support layer 32 close to the cross dichroic prism 500.

In the projector 1000 according to the first embodiment of the invention, since the cured coating layer HC is formed at the surface of the support layer 32 facing the cross dichroic prism 500, the adhesive layer C is formed at the surface of the cured coating layer HC, not the surface of the support layer 32. If the cured coating layer HC is formed at the surface of the light-emergent-side polarizing plate 430R facing the cross dichroic prism 500, an adhesive property between the light-emergent-side polarizing plate 430R and the cross dichroic prism 500 increases. Accordingly, the projector 1000 according to the first embodiment of the invention becomes a projector that can suppress the light-emergent-side polarizing plate 430R from being easily separated from the cross dichroic prism 500 due to an increase in temperature of the light-emergent-side polarizing plate 430R compared with the known projector, and therefore becomes a projector that can suppress deterioration of image quality of a projected image.

In the projector 1000 according to the first embodiment of the invention, the cross dichroic prism 500 is formed of vitreous silica, borosilicate glass, or other light-transmissive glass. Since this material has a small birefringence, degradation of quality of a light flux passing through the cross dichroic prism 500 can be suppressed, and degradation of quality of a light flux emitted from the light-emergent-side polarizing plate 430R can be suppressed. Further, since the above-described material has a comparatively small thermal expansion coefficient, when the light-emergent-side polarizing plate 430R having large expansion or deformation due to heat is bonded to the cross dichroic prism 500 formed of such a material having a small thermal expansion coefficient, deformation of the light-emergernt-side polarizing plate 430R can be suppressed.

In the projector 1000 according to the first embodiment of the invention, as shown in FIG. 4B, the cured coating layer HC is formed at the surface of the phase plate 40 facing the polarization separating prism 142.

In the projector 1000 according to the first embodiment of the invention, since the cured coating layer HC is formed at the surface of the phase plate 40 facing the polarization separating prism 142, the adhesive layer C is formed at the surface of the cured coating layer HC, not the surface of the phase plate 40. If the cured coating layer HC is formed at the surface of the phase plate 40 facing the polarization separating prism 142, a adhesive property between the phase plate 40 and the polarization separating prism 142 increases. Accordingly, the projector 1000 according to the first embodiment of the invention becomes a projector that can suppress the phase plate 40 from being easily separated from the polarization separating prism 142 due to an increase in temperature of the phase plate 40 compared with the known projector, and therefore becomes a projector that can suppress deterioration of image quality of a projected image.

In the projector 1000 according to the first embodiment of the invention, the polarization separating prism 142 is formed of sapphire. Since sapphire exhibits excellent thermal conductivity, heat generated from the phase plate 40 can be efficiently dissipated outside the system, and the increase in temperature of the phase plate 40 can be effectively suppressed. Further, since sapphire has a small thermal expansion coefficient, when the phase plate 40 having large expansion or deformation due to heat is bonded to the polarization separating prism 142 formed of such a material having a small thermal expansion coefficient, the deformation of the phase plate 40 can be suppressed.

In the projector 1000 according to the first embodiment of the invention, as an adhesive used in the adhesive layer C, an acryl-based adhesive is used. Further, as the cured coating layer HC, acryl-based resin is used. That is, the adhesive layer C and the cured coating layer HC are formed of the same kind of material.

Accordingly, the adhesive force between the light-incident-side polarizing plates 420R, 420G, and 420B and the collective lenses 300R, 300G, and 300B and between the light-emergent-side polarizing plates 430R, 430G, and 430B and the cross dichroic prism 500, or between the phase plate 40 and the polarization separating prism 142 can be further increased, the light-incident-side polarizing plate, the light-emergent-side polarizing plate, or the phase plate can be further suppressed from being easily separated from the collective lens, the cross dichroic prism, or the polarization separating prism. Further, reflection of light at the interface between the cured coating layer HC and the adhesive layer C can be suppressed, and thus a loss of a light amount due to such undesirable reflection can be reduced.

In order to confirm the effects of the cured coating layer in the first embodiment of the invention, the inventors have performed a cutting experiment under an condition of a contact area 5 [mm]×5 [mm] on a sample 1 in which a polarizing plate is bonded to borosilicate glass in a state where the cured coating layer is formed, and a sample 2 in which a polarizing plate is bonded to borosilicate glass in a state where the cured coating layer is not formed. As the adhesive, an ultraviolet curable acryl-based adhesive was used, and a support layer formed of triacetyl cellulose (TAC) was disposed on the polarizing plate close to borosilicate glass.

As the result of the experiment, while adhesive strength 40 [gf/mm²] was obtained in the sample 2, adhesive strength 70 [gf/mm²] was obtained in the sample 1. Accordingly, the effects of the cured coating layer in the first embodiment of the invention were confirmed.

In the projector 1000 according to the first embodiment of the invention, as an adhesive used in the adhesive layer C, an ultraviolet curable adhesive or a short wavelength visible light curable adhesive may be suitably used.

In the projector 1000 according to the first embodiment of the invention, as shown in FIG. 2B, a cooling air flow passage that cools the light-incident-side polarizing plates 420R, 420G, and 420B and the light-emergent-side polarizing plates 430R, 430G, and 430B is provided. Accordingly, since the light-incident-side polarizing plates 420R, 420G, and 420B and the light-emergent-side polarizing plates 430R, 430G, and 430B can be cooled by cooling air from the cooling air flow passage, the increase in temperature of the light-incident-side polarizing plates 420R, 420G, and 420B and the light-emergent-side polarizing plates 430R, 430G, and 430B can be suppressed. Therefore, heat generated from the light-incident-side polarizing plates 420R, 420G, and 420B and the light-emergent-side polarizing plates 430R, 430G, and 430B can be efficiently eliminated.

Moreover, though not shown, in the projector 1000, at least one fan and a plurality of cooling air flow passages for cooling the individual optical systems are provided. Air introduced from the outside of the projector 1000 is circulated inside the projector 1000 and then discharged to the outside.

### Second Embodiment

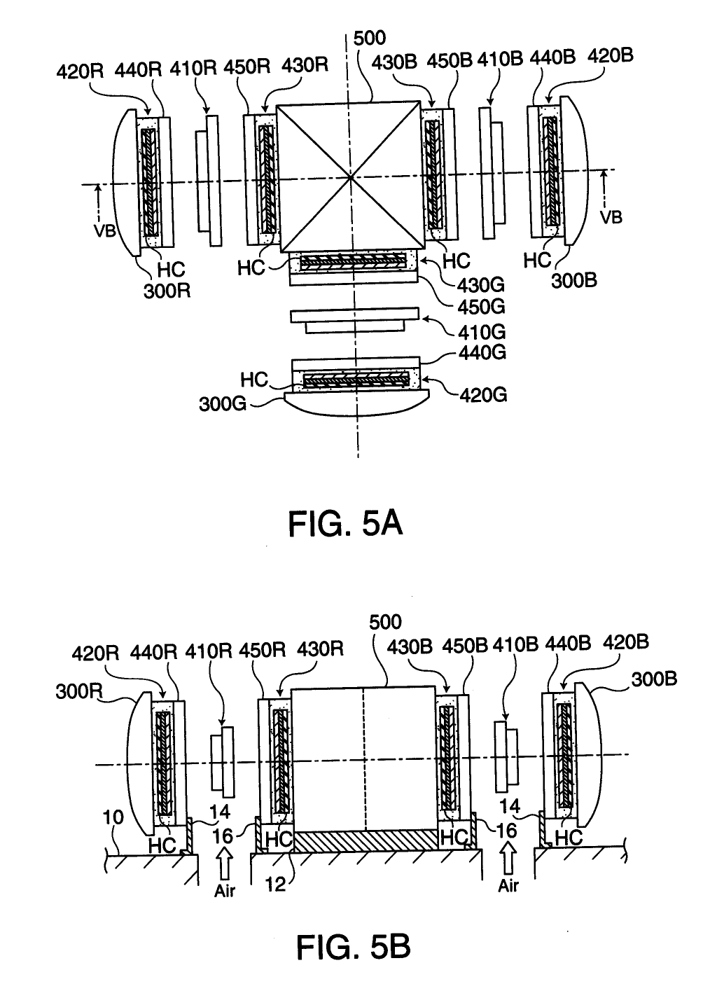

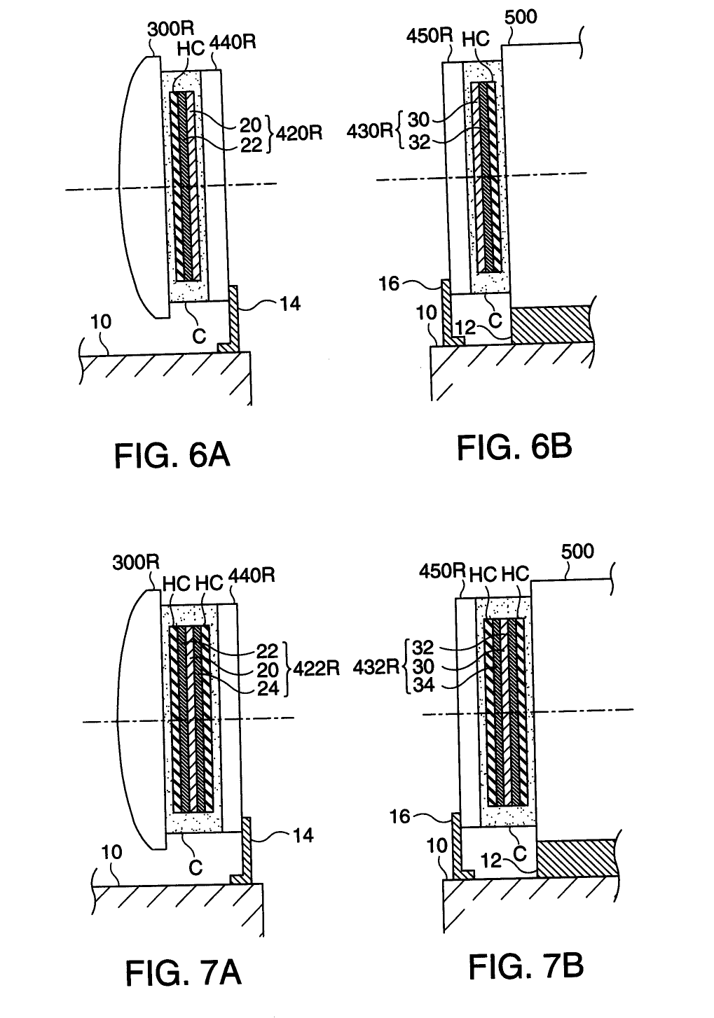

FIGS. 5A to 6B are diagrams illustrating main parts of a projector 1002 according to a second embodiment of the invention. Specifically, FIG. 5A is a diagram of the periphery of a cross dichroic prism 500 as viewed from the top, and FIG. 5B is a cross-sectional view taken along the line VB-VB of FIG. 5A. FIG. 6A is a diagram of the periphery of a light-incident-side polarizing plate 420R as viewed from the side, and FIG. 6B is a diagram of the periphery of a light-emergent-side polarizing plate 430R as viewed from the side. Moreover, in FIGS. 5A to 6B, the same parts as those in the FIGS. 2A to 3B are represented by the same reference numerals, and the detailed descriptions thereof will be omitted.

The projector 1002 (not shown) according to the second embodiment of the invention basically has the configuration almost similar to the projector 1000 according to the first embodiment of the invention, but is different from the projector 1000 according to the first embodiment of the invention in that light-transmissive substrates are further provided as additional optical elements.

That is, the projector 1002 according to the second embodiment of the invention further includes light-transmissive substrates 440R, 440G, and 440B that are disposed at an opposite side of the light-incident-side polarizing plates 420R, 420G, and 420B from the collective lenses 300R, 300G, and 300B and are bonded to the light-incident-side polarizing plates 420R, 420G, and 420B through a adhesive layer C, respectively, and light-transmissive substrates 450R, 450G, and 450B that are disposed at an opposite side of the light-emergent-side polarizing plates 430R, 430G, and 430B from the cross dichroic prism 500 and are bonded to the light-emergent-side polarizing plates 430R, 430G, and 430B through the adhesive layer C, respectively.

As such, the projector 1002 according to the second embodiment of the invention is different from the projector 1000 according to the first embodiment of the invention in that the light-transmissive substrates are further provided as additional optical elements. However, like the projector 1000 according to the first embodiment of the invention, as shown in FIG. 6A, since a cured coating layer HC is formed at the surface of the light-incident-side polarizing plate 420R facing the collective lens 300R, the projector 1002 according to the second embodiment of the invention becomes a projector that can suppress the light-incident-side polarizing plate 420R from being easily separated from the collective lens 300R due to an increase in temperature of the light-incident-side polarizing plate 420R compared with the known projector, and therefore becomes a projector that can suppress deterioration of image quality of a projected image. Further, as shown in FIG. 6B, since a cured coating layer HC is formed at the surface of the light-emergent-side polarizing plate 430R facing the cross dichroic prism 500, the projector 1002 according to the second embodiment of the invention becomes a projector that can suppress the light-emergent-side polarizing plate 430R from being easily separated from the cross dichroic prism 500 due to an increase in temperature of the light-emergent-side polarizing plate 430R compared with the known projector, and therefore becomes a projector that can suppress deterioration of image quality of a projected image.

In the projector 1002 according to the second embodiment of the invention, since the light-transmissive substrates 440R, 440G, and 440B that are bonded to the light-incident-side polarizing plates 420R, 420G, and 420B through the adhesive layer C, heat generated from the light-incident-side polarizing plates 420R, 420G, and 420B can also be transferred to the light-transmissive substrates 440R, 440G, and 440B, and thus the increase in temperature of the light-incident-side polarizing plates 420R, 420G, and 420B can be further suppressed. For this reason, occurrence of thermal deformation of the light-incident-side polarizing plates 420R, 420G, and 420B can be further suppressed, and the light-incident-side polarizing plates 420R, 420G, and 420B can be further suppressed from being easily separated from the collective lenses 300R, 300G, and 300B due to the increase in temperature of the light-incident-side polarizing plates 420R, 420G, and 420B.

In the projector 1002 according to the second embodiment of the invention, since the light-transmissive substrates 450R, 450G, and 450B that are bonded to the light-emergent-side polarizing plates 430R, 430G, and 430B through the adhesive layer C, heat generated from the light-emergent-side polarizing plates 430R, 430G, and 430B can also be transferred to the light-transmissive substrates 450R, 450G, and 450B, and thus the increase in temperature of the light-emergent-side polarizing plates 430R, 430G, and 430B can be further suppressed. For this reason, occurrence of thermal deformation of the light-emergent-side polarizing plates 430R, 430G, and 430B can be further suppressed, and the light-emergent-side polarizing plates 430R, 430G, and 430B can be further suppressed from being easily separated from the cross dichroic prism 500 due to the increase in temperature of the light-emergent-side polarizing plates 430R, 430G, and 430B.

In the projector 1002 according to the second embodiment of the invention, the light-transmissive substrates 440R, 440G, 440B, 450R, 450G, and 450B are formed of sapphire. Since sapphire exhibits excellent thermal conductivity, heat generated from the light-incident-side polarizing plates 420R, 420G, and 420B and the light-emergent-side polarizing plates 430R, 430G, and 430B can be efficiently dissipated outside the system, and the increase in temperature of the light-incident-side polarizing plates 420R, 420G, and 420B and the light-emergent-side polarizing plates 430R, 430G, and 430B can be effectively suppressed. Further, since sapphire has a small thermal expansion coefficient, when the light-incident-side polarizing plates 420R, 420G, and 420B and the light-emergent-side polarizing plates 430R, 430G, and 430B having large expansion or deformation due to heat are bonded to the light-transmissive substrates 440R, 440G, 440B, 450R, 450G, and 450B formed of such a material having a small thermal expansion coefficient, respectively, the deformation of the light-incident-side polarizing plates 420R, 420G, and 420B and the light-emergent-side polarizing plates 430R, 430G, and 430B can be suppressed.

Moreover, the thickness of each of the light-transmissive substrates 440R, 440G, 440B, 450R, 450G, and 450B is preferably 0.2 mm or more in terms of thermal conductivity, or is preferably 2.0 mm or less in terms of reduction in size of the apparatus.

In the projector 1002 according to the second embodiment of the invention, as shown in FIGS. 5B and 6A, thermal conductive members 14 are respectively provided to transfer heat between the light-transmissive substrates 440R, 440G, and 440B and the casing 10. For this reason, heat generated from the light-incident-side polarizing plates 420R, 420G, and 420B is dissipated to the casing 10 through the light-transmissive substrates 440R, 440G, and 440B and the thermal conductive members 14, and thus heat radiation performance of the projector can be increased.

In the projector 1002 according to the second embodiment of the invention, as shown in FIGS. 5B and 6B, thermal conductive members 16 are provided to transfer heat between the light-transmissive substrates 450R, 450G, and 450B and the casing 10. For this reason, heat generated from the light-emergent-side polarizing plates 430R, 430G, and 430B is dissipated to the casing 10 through the light-transmissive substrates 450R, 450G, and 450B and the thermal conductive members 16, and thus heat radiation performance of the projector can be increased.

As the material of the thermal conductive members 14 and 16, for example, a metal, such as aluminum or an aluminum alloy, may be preferably used.

### Third Embodiment

FIGS. 7A and 7B are diagrams illustrating main parts of a projector 1004 according to a third embodiment of the invention. Specifically, FIG. 7A is a diagram of the periphery of a light-incident-side polarizing plate 422R as viewed from the side, and FIG. 7B is a diagram of the periphery of a light-emergent-side polarizing plate 432R as viewed from the side. Moreover, in FIGS. 7A and 7B, the same parts as those in FIGS. 6A and 6B are represented by the same reference numerals, and the detailed descriptions thereof will be omitted.

The projector 1004 (not shown) according to the third embodiment of the invention basically has the configuration almost similar to the projector 1002 according to the second embodiment of the invention, but is different from the projector 1002 according to the second embodiment of the invention in that three-layered light-incident-side polarizing plate and light-emergent-side polarizing plate are used, as shown in FIGS. 7A and 7B.

That is, in the projector 1004 according to the third embodiment of the invention, as shown in FIG. 7A, the light-incident-side polarizing plate 422R is a three-layered polarizing plate that has a polarizing layer 20, and two support layers 22 and 24 supporting the polarizing layer 20 from both surfaces. Further, as shown in FIG. 7B, the light-emergent-side polarizing plate 432R is a three-layered polarizing plate that has a polarizing layer 30, and two support layers 32 and 34 supporting the polarizing layer 30 from both surfaces. Other light-incident-side polarizing plates 422G and 422B or other light-emergent-side polarizing plates 432G and 432B have the same configuration as the light-incident-side polarizing plate 422R or the light-emergent-side polarizing plate 432R. Moreover, the materials forming the polarizing layer and the support layer are the same as those described in the first embodiment of the invention.

The effects of the projector 1004 according to the third embodiment of the invention will now be described. Hereinafter, for simple explanation, the effects of the projector 1004 according to the third embodiment of the invention will be described on the basis of the members disposed in the optical path of a red light component among the optical paths of three color light components.

In the projector 1004 according to the third embodiment of the invention, as shown in FIG. 7A, the light-incident-side polarizing plate 422R has the polarizing layer 20 and the support layers 22 and 24 supporting the polarizing layer 20. Then, the light-incident-side polarizing plate 422R is bonded to the light emergent surface of the collective lens 300R and the light incident surface of the light-transmissive substrate 440R through a adhesive layer C such that the support layer 22 is disposed on the polarizing layer 20 close to the collective lens 300R (the support layer 24 is disposed on the polarizing layer 20 close to the light-transmissive substrate 440R). Cured coating layers HC are formed at a surface of the support layer 22 where the polarizing layer 20 is not disposed (a surface facing the collective lens 300R) and a surface of the support layer 24 where the polarizing layer 20 is not disposed (a surface facing the light-transmissive substrate 440R) through deposition or the like.

In the projector 1004 according to the third embodiment of the invention, since the cured coating layers HC are formed at the surface of the support layer 22 facing the collective lens 300R and the surface of the support layer 24 facing the light-transmissive substrate 440R, the adhesive layers C are formed at the surfaces of the cured coating layers HC, not the surfaces of the support layers 22 and 24. If the cured coating layers HC are formed at the surface facing the collective lens 300R and the surface facing the light-transmissive substrate 440R on the light-incident-side polarizing plate 422R, a adhesive property between the light-incident-side polarizing plate 422R and the collective lens 300R and a adhesive property between the light-incident-side polarizing plate 422R and the light-transmissive substrate 440R increase. Accordingly, the projector 1004 according to the third embodiment of the invention becomes a projector that can suppress the light-incident-side polarizing plate 422R from being easily separated from the collective lens 300R and the light-transmissive substrate 440R due to the increase in temperature of the light-incident-side polarizing plate 422R compared with the known projector, and therefore becomes a projector that can suppress deterioration of image quality of a projected image.

In the projector 1004 according to the third embodiment of the invention, as shown in FIG. 7B, the light-emergent-side polarizing plate 432R has the polarizing layer 30 and the support layers 32 and 34 supporting the polarizing layer 30. Then, the light-emergent-side polarizing plate 432R is bonded to the light incident end surface of the cross dichroic prism 500 and the light emergent surface of the light-transmissive substrate 450R through the adhesive layer C such that the support layer 32 is disposed at a surface of the polarizing layer 30 facing the cross dichroic prism 500 (the support layer 34 is disposed at a surface of the polarizing layer 30 facing the light-transmissive substrate 450R). The cured coating layers HC are formed at a surface of the support layer 32 where the polarizing layer 30 is not disposed (a surface facing the cross dichroic prism 500) and a surface of the support layer 34 where the polarizing layer 30 is not disposed (a surface facing the light-transmissive substrate 450R) through deposition or the like.

In the projector 1004 according to the third embodiment of the invention, since the cured coating layers HC are formed at the surface of the support layer 32 facing the cross dichroic prism 500 and the surface of the support layer 34 facing the light-transmissive substrate 450R, the adhesive layer C is formed at the surfaces of the cured coating layers HC, not the surfaces of the support layers 32 and 34. If the cured coating layers HC are formed at the surface facing the cross dichroic prism 500 and the surface facing the light-transmissive substrate 450R on the light-emergent-side polarizing plate 432R, a adhesive property between the light-emergent-side polarizing plate 432R and the cross dichroic prism 500 and a adhesive property between the light-emergent-side polarizing plate 432R and the light-transmissive substrate 450R increase. Accordingly, the projector 1004 according to the third embodiment of the invention becomes a projector that can suppress the light-emergent-side polarizing plate 432R from being easily separated from the cross dichroic prism 500 and the light-transmissive substrate 450R due to an increase in temperature of the light-emergent-side polarizing plate 432R compared with the known projector, and therefore a projector that can suppress deterioration of image quality of a projected image.

### Fourth Embodiment

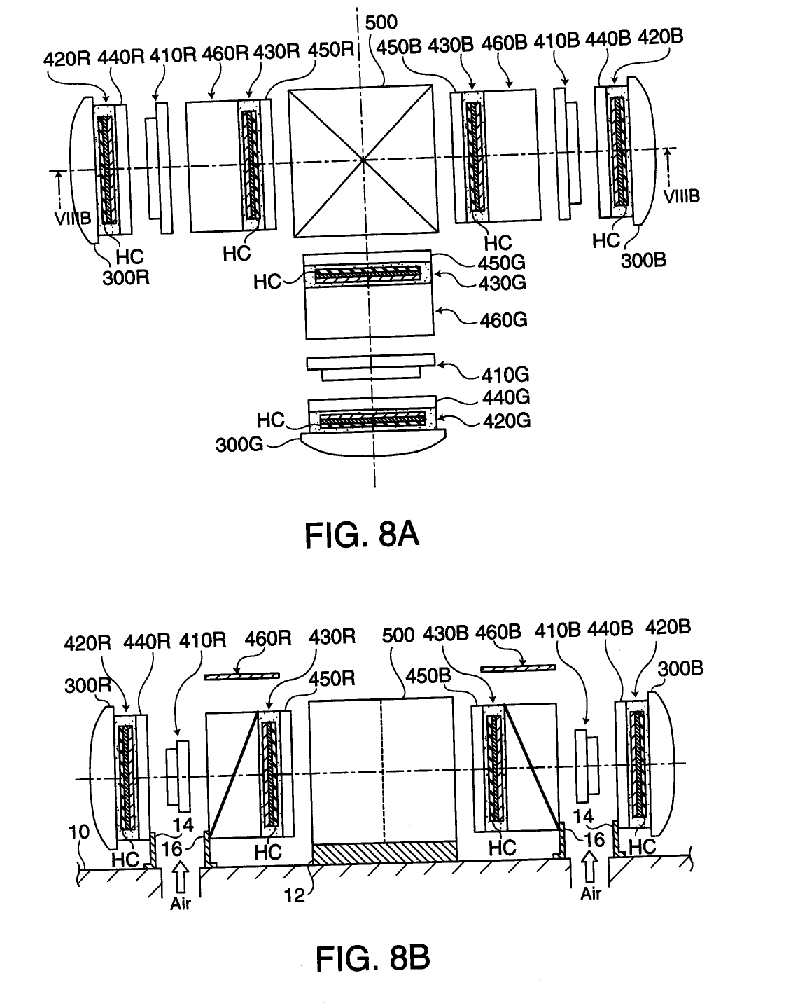

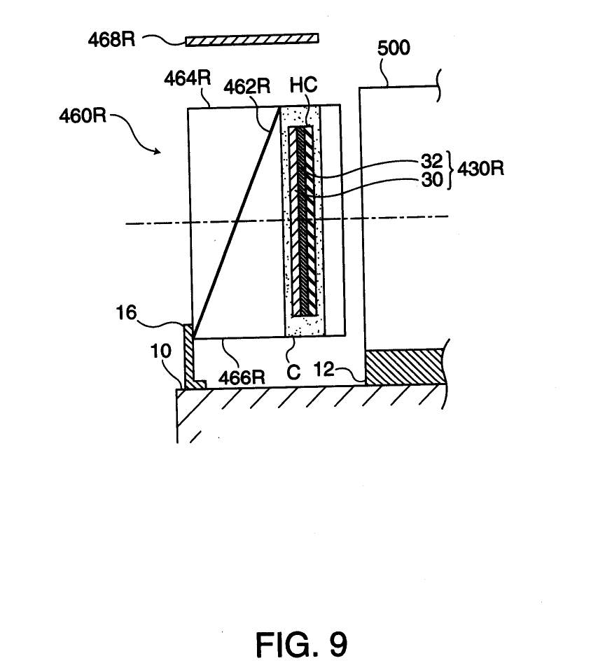

FIGS. 8A and 8B are diagrams illustrating main parts of a projector 1006 according to a fourth embodiment of the invention. Specifically, FIG. 8A is a diagram of the periphery of a cross dichroic prism 500 as viewed from the top, and FIG. 8B is a cross-sectional view taken along the line VIIIB-VIIIB of FIG. 8A. FIG. 9 is a diagram of the periphery of a light-emergent-side polarizing plate 430R as viewed from the side. Moreover, in FIGS. 8A to 9, the same parts as those in FIGS. 5A to 6B are represented by the same reference numerals, and the detailed descriptions thereof will be omitted.

The projector 1006 (not shown) according to the fourth embodiment of the invention basically has the configuration almost similar to the projector 1002 according to the second embodiment of the invention, but is different from the projector 1002 according to the second embodiment of the invention in that an optical element to be bonded to the light-emergent-side polarizing plate is a polarization separating prism, not the cross dichroic prism, as shown in FIGS. 8A to 9.

That is, in the projector 1002 according to the second embodiment of the invention, as shown in FIGS. 5A and 5B, the light-emergent-side polarizing plates 430R, 430G, and 430B are respectively bonded to the light incident end surfaces of the cross dichroic prism 500 as an optical element through the adhesive layer C. Further, the light-transmissive substrates 450R, 450G, and 450B as the additional optical elements are respectively disposed on the light incident sides of the light-emergent-side polarizing plates 430R, 430G, and 430B, and the light-emergent-side polarizing plates 430R, 430G, and 430B are bonded to the light-transmissive substrates 450R, 450G, and 450B through the adhesive layer C, respectively.

In contrast, in the projector 1006 according to the fourth embodiment of the invention, as shown in FIGS. 8A and 8B, light-emergent-side polarizing plates 430R, 430G, and 430B are respectively bonded to light emergent surfaces of polarization separating prisms 460R, 460G, and 460B as optical elements through an adhesive layer C. Further, light-transmissive substrates 450R, 450G, and 450B as additional optical elements are respectively disposed on the light emergent sides of the light-emergent-side polarizing plates 430R, 430G, and 430B, and the light-emergent-side polarizing plates 430R, 430G, and 430B are bonded to the light-transmissive substrates 450R, 450G, and 450B through the adhesive layer C, respectively.

As such, the projector 1006 according to the fourth embodiment of the invention is different from the projector 1002 according to the second embodiment of the invention in that the optical element to be bonded to the light-emergent-side polarizing plate is the polarization separating prism, not the cross dichroic prism. Meanwhile, like the projector 1002 according to the second embodiment of the invention, as shown in FIGS. 8A and 8B, since the cured coating layer HC is formed at the surface of the light-incident-side polarizing plate 420R facing the collective lens 300R, the projector 1006 according to the fourth embodiment of the invention becomes a projector that can suppress the light-incident-side polarizing plate 420R from being easily separated from the collective lens 300R due to an increase in temperature of the light-incident-side polarizing plate 420R compared with the known projector, and therefore a projector that can suppress deterioration of image quality of a projected image.

The effects of the projector 1006 according to the fourth embodiment of the invention will now be described. Hereinafter, for simple explanation, the configuration and the effects of the projector 1006 according to the fourth embodiment of the invention will be described on the basis of the members disposed in the optical path of a red light component among the three color light components.

In the projector 1006 according to the fourth embodiment of the invention, as shown in FIGS. 8A to 9, the polarization separating prism 460R is disposed on the light emergent side of the light-emergent-side polarizing plate 430R. The polarization separating prism 460R is an optical element that transmits linear polarized light components having an axis of a predetermined direction among the light components emitted from the liquid crystal panel 410R and reflects other light components. As shown in FIG. 9, the polarization separating prism 460R has a structure in which an XY-type polarizing film 462R is interposed between two glass prisms 464R and 466R. The XY-type polarizing film 462R is formed by laminating a plurality of films having biaxial directionality and has an XY-type polarization characteristic. An angle between a light incident surface of the polarization separating prism 460R and the XY-type polarizing film 462R is set to, for example, 30°.

In the projector 1006 according to the fourth embodiment of the invention, as shown in FIGS. 8A to 9, the light-emergent-side polarizing plate 430R has a polarizing layer 30, and a support layer 32 supporting the polarizing layer 30. Then, the light-emergent-side polarizing plate 430R is bonded to a light emergent surface of the polarization separating prism 460R and a light incident surface of the light-transmissive substrate 450R through the adhesive layer C such that the support layer 32 is located at a surface of the polarizing layer 30 facing the light-transmissive substrate 450R. The cured coating layer HC is formed at the surface of the support layer 32 where the polarizing layer 30 is not disposed (the surface facing the light-transmissive substrate 450R) through deposition or the like.

In the projector 1006 according to the fourth embodiment of the invention, since the cured coating layer HC is formed at the surface of the support layer 32 facing the light-transmissive substrate 450R, the adhesive layer C is formed at the surface of the cured coating layer HC, not the surface of the support layer 32. If the cured coating layer HC is formed at the surface of the light-emergent-side polarizing plate 430R facing the light-transmissive substrate 450R, a adhesive property between the light-emergent-side polarizing plate 430R and the light-transmissive substrate 450R increases. Accordingly, the projector 1006 according to the fourth embodiment of the invention becomes a projector that can suppress the light-emergent-side polarizing plate 430R from being easily separated from the light-transmissive substrate 450R due to the increase in temperature of the light-emergent-side polarizing plate 430R, and therefore a projector that can suppress deterioration of image quality of a projected image.

In the projector 1006 according to the fourth embodiment of the invention, linear polarized light components having an axis of a predetermined direction among the light components emitted from the liquid crystal panel 410R transmit the polarization separating prism 460R, then are projected onto the projecting optical system 600 (not shown), and subsequently are projected onto the screen SCR (not shown). Other light components, that is, light components that are to be inhibited from entering the projecting optical system 600 are reflected by the polarization separating prism 460R and are released outside the system. For this reason, among the light components incident on the light-emergent-side polarizing plate 430R, the light components that are to be inhibited from entering the projecting optical system 600 are almost eliminated by the polarization separating prism 460R as a front stage. Accordingly, heat generation in the light-emergent-side polarizing plate 430R can be effectively suppressed, and the increase in temperature of the light-emergent-side polarizing plate 430R can be further effectively suppressed.

Further, the XY-type polarizing film 462R of the polarization separating prism 460R is a reflective polarizing plate and is configured to be inclined with respect to the illumination light axis 100ax (not shown), a characteristic as an analyzer is slightly lost. However, since unnecessary light components for an image that are not eliminated by the polarization separating prism 460R can be reliably blocked by the light-emergent-side polarizing plate 430R, a good image can be obtained.

That is, the operation as the analyzer and heat generation are allotted to the polarization separating prism 460R and the light-emergent-side polarizing plate 430R, and thus reliability of the apparatus can be improved.

In the projector 1006 according to the fourth embodiment of the invention, a polarized light component reflected by the XY-type polarizing film 462R among the light components modulated by the liquid crystal panel 410R is emitted from the side surface of the polarization separating prism 460R as it is or is reflected at the light incident surface of the polarization separating prism 460R and then emitted from the upper surface of the polarization separating prism 460R. In this case, total reflection is made at the light incident surface of the polarization separating prism 460R, and thus a level of stray light can be reduced.

In the projector 1006 according to the fourth embodiment of the invention, a light absorbing unit 468R is provided above the polarization separating prism 460R so as to absorb the polarized light component reflected by the XY-type polarizing film 462R and emitted from the polarization separating prism 460R. Accordingly, since the light absorbing unit 468R effectively traps the light component reflected by the XY-type polarizing film 462R and released outside the system, occurrence of stray light in the projector can be suppressed and thus image quality of a projected image can be further improved. Further, since the light absorbing unit 468R is provided above the polarization separating prism 460R, heat generated from the light absorbing unit 468R is released above the optical system through convection, and thus an influence by heat on the optical system can be minimized.

### Fifth Embodiment

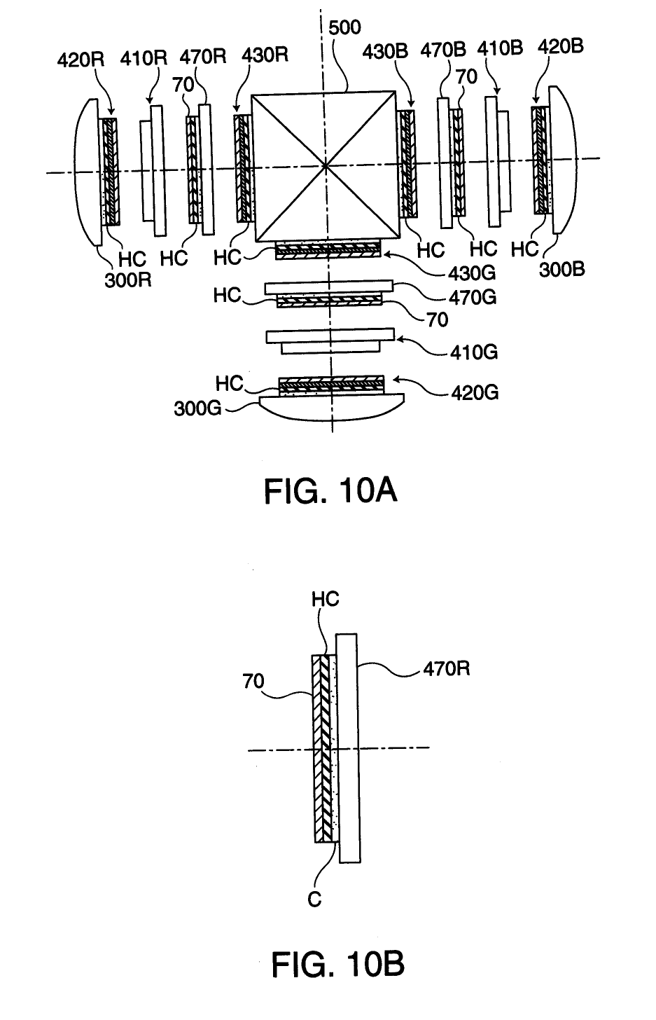

FIGS. 10A and 10B are diagrams illustrating main parts of a projector 1008 according to a fifth embodiment of the invention. Specifically, FIG. 10A is a diagram of the periphery of a cross dichroic prism 500 as viewed from the top, and FIG. 10B is a diagram illustrating a viewing angle compensating plate 70. Moreover, in FIGS. 10A and 10B, the same parts as those in the FIGS. 2A and 2B are represented by the same reference numerals, and the detailed descriptions thereof will be omitted.

The projector 1008 (not shown) according to the fifth embodiment of the invention basically has the configuration almost similar to the projector 1000 according to the first embodiment of the invention, but is different from the projector 1000 according to the first embodiment of the invention in that a viewing angle compensating plate is further provided, as shown in FIGS. 10A and 10B. Hereinafter, the features and effects of the projector 1008 according to the fifth embodiment of the invention will be described.

In the projector 1008 according to the fifth embodiment of the invention, as shown in FIGS. 10A and 10B, viewing angle compensating plates 70 are respectively disposed between the liquid crystal panels 410R, 410G, and 410B and the light-emergent-side polarizing plates 430R, 430G, and 430B.

The viewing angle compensating plates 70 are respectively bonded to light-transmissive substrates 470R, 470G, and 470B as optical elements through an adhesive layer C.

In the projector 1008 according to the fifth embodiment of the invention, cured coating layers HC are formed at surfaces of the viewing angle compensating plates 70 facing the light-transmissive substrates 470R, 470G, and 470B.

In the projector 1008 according to the fifth embodiment of the invention, since the cured coating layers HC are formed at the surfaces of the viewing angle compensating plates 70 facing the light-transmissive substrates 470R, 470G, and 470B, the adhesive layer C is formed at the surfaces of the cured coating layers HC, not the surfaces of the viewing angle compensating plates 70. If the cured coating layers HC are formed at the surfaces of the viewing angle compensating plates 70 facing the light-transmissive substrates 470R, 470G, and 470B, a adhesive property between the viewing angle compensating plates 70 and the light-transmissive substrates 470R, 470G, and 470B increases. Accordingly, the projector 1008 according to the fifth embodiment of the invention becomes a projector that can suppress the viewing angle compensating plates 70 from being easily separated from the light-transmissive substrates 470R, 470G, and 470B compared with the known projector, and therefore a projector that can suppress deterioration of image quality of a projected image.

Moreover, the projector 1008 according to the fifth embodiment of the invention has the same configuration as the projector 1000 according to the first embodiment of the invention, except that the viewing angle compensating plates are further provided, and thus the same effects as the projector 1000 according to the first embodiment of the invention can be obtained.

### Sixth Embodiment

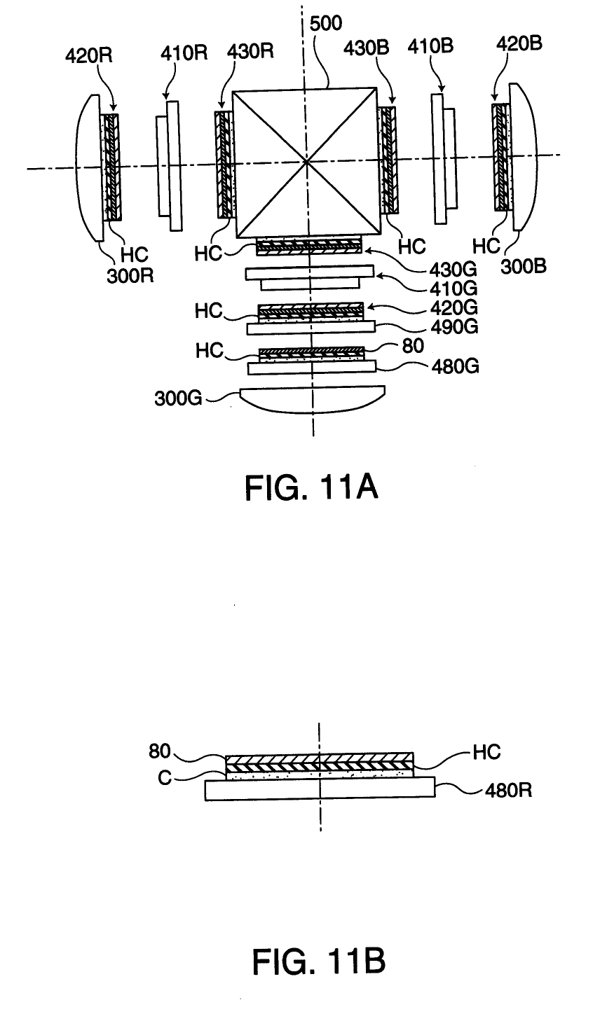

FIGS. 11A and 11B are diagrams illustrating main parts of a projector 1010 according to a sixth embodiment of the invention. Specifically, FIG. 11A is a diagram of the periphery of a cross dichroic prism 500 as viewed from the top, and FIG. 11B is a diagram illustrating a phase plate 80. Moreover, in FIGS. 11A and 11B, the same parts as those in FIGS. 2A and 2B are represented by the same reference numerals, and the detailed descriptions thereof will be omitted.

The projector 1010 (not shown) according to the sixth embodiment of the invention basically has the configuration almost similar to the projector 1000 according to the first embodiment of the invention, but is different from the projector 1000 according to the first embodiment of the invention in that a phase plate is further provided, as shown in FIGS. 11A and 11B. Hereinafter, the features and effects of the projector 1010 according to the sixth embodiment of the invention will be described.

In the projector 1010 according to the sixth embodiment of the invention, as shown in FIG. 11A, the phase plate 80 is disposed between a collective lens 300G and a light-incident-side polarizing plate 424G in an optical path for green light. Accordingly, it is possible to optimize the polarization direction of each color light component and to maximize light pass efficiency of each color light component in a dichroic mirror, a reflecting mirror, or a cross dichroic prism.

The phase plate 80 is bonded to a light-transmissive substrate 480G as an optical element through an adhesive layer C. Moreover, in the projector 1010 according to the sixth embodiment of the invention, the light-incident-side polarizing plate 424G is bonded to a light-transmissive substrate 490G, not to the collective lens 300R, through the adhesive layer C.

In the projector 1010 according to the sixth embodiment of the invention, as shown in FIG. 11B, a cured coating layer HC is formed at a surface of the phase plate 80 facing the light-transmissive substrate 480G.

In the projector 1010 according to the sixth embodiment of the invention, since the cured coating layer HC is formed at the surface of the phase plate 80 facing the light-transmissive substrate 480G, the adhesive layer C is formed at the surface of the cured coating layer HC, not the surface of the phase plate 80. If the cured coating layer HC is formed at the surface of the phase plate 80 facing the light-transmissive substrate 480G, an adhesive property between the phase plate 80 and the light-transmissive substrate 480G increases. Accordingly, the projector 1010 according to the sixth embodiment of the invention becomes a projector that can suppress the phase plate 80 from being easily separated from the light-transmissive substrate 480G due to the increase in temperature of the phase plate 80 compared with the known projector, and therefore a projector that can suppress deterioration of image quality of a projected image.

In the projector 1010 according to the sixth embodiment of the invention, the light-transmissive substrate 480G is formed of sapphire. Since sapphire has excellent thermal conductivity, heat generated from the phase plate 80 can be efficiently dissipated outside the system, and the increase in temperature of the phase plate 80 can be effectively suppressed. Further, since sapphire has a small thermal expansion coefficient, when the phase plate 80 having large expansion and deformation due to heat is bonded to the light-transmissive substrate 480G formed of such a material having a small thermal expansion efficiency, deformation of the phase plate 80 can be suppressed.

The projector 1010 according to the sixth embodiment of the invention has the same configuration as the projector 1000 according to the first embodiment of the invention, except that the phase plate is further provided. Accordingly, the same effects as the projector 1000 according to the first embodiment of the invention can be obtained.

As described above, although the projector and the optical part of the invention will be described by way of the above-described embodiments, the invention is not limited to the embodiments, and various modifications can be made within the scope without departing from the subject matter of the invention. For example, the following modifications can be made.

(1) Although a case where sapphire is used as a material of the light-transmissive substrate as an optical element has been described in the projectors 1000 to 1010 of the individual embodiments, the invention is not limited thereto. For example, quartz, vitreous silica, borosilicate glass, or other optical glass, or crystallized glass may be used.

(2) Although a case where the light-incident-side polarizing plate is bonded to the collective lens as an optical element has been described in the projectors 1000 to 1006 of the individual 1 to 4 embodiments, the invention is not limited thereto. For example, in a projector that uses a lens other than the collective lens, the invention can be applied to a case where the light-incident-side polarizing plate, the light-emergent-side polarizing plate, the viewing angle compensating plate, or the phase plate is bonded to such a lens.

(3) Although the acryl adhesive is used as the adhesive for the adhesive layer C in the projectors 1000 to 1010 of the individual embodiments, the invention is not limited thereto. For example, a silicon-based adhesive or an epoxy-based adhesive may be used.

(4) Although acryl-based resin is used as the cured coating layer HC in the projectors 1000 to 1010 of the individual embodiments, the invention is not limited thereto. For example, silicon-based resin, melamine-based resin, urethane-based resin, or epoxy-based resin may be used.

(5) Although a case where the viewing angle compensating plate 70 is disposed between the liquid crystal panel and the light-emergent-side polarizing plate has been described in the projector 1008 according to the fifth embodiment of the invention, the invention is not limited thereto. For example, the viewing angle compensating plate may be disposed between the light-incident-side polarizing plate and the liquid crystal panel.

(6) Although a case where the phase plate 80 is bonded to the light-transmissive substrate 480G has been described in the projector 1010 according to the sixth embodiment of the invention, the invention is not limited thereto. For example, the phase plate may be bonded to the light emergent surface of the collective lens 300G as an optical element.

(7) Although the polarization separating prisms 460R, 460G, and 460B that use the XY-type polarizing film formed by laminating a plurality of films having biaxial directionality so as to have an XY-type polarization characteristic are illustrated in the projector 1006 according to the fourth embodiment of the invention, the invention is not limited thereto. For example, as the polarization separating prism, a polarization separating prism formed of a multilayer dielectric film, or a wire grid-type polarization separating prism having a plurality of minute metal lines may be used.

(8) Although the light source device 110 having the ellipsoidal reflector 114, the light-emitting tube 112 having a light emission center in the vicinity of the first focus of the ellipsoidal reflector 114, and the concave lens 118 is used as the light source device 110 in the projectors 1000 to 1010 of the individual embodiments, the invention is not limited thereto. For example, a light source device having a paraboloidal reflector and a light-emitting tube having a light emission center in the vicinity of a focus of the paraboloidal reflector may be used.

(9) Although the projectors that use the three liquid crystal panels 410R, 410G, and 410B are illustrated in the individual embodiments, the invention is not limited thereto. For example, the invention can be applied to a projector that uses one, two, or four liquid crystal devices.

(10) The invention can be applied to a front projection-type projector that projects a projected image from an observation side or a rear projection-type projector that projects a projected image from the side opposite to the observation side.

What is claimed is:

1. A projector comprising:
an optical element; and
a polarizing plate that is bonded to the optical element through an adhesive layer, the polarizing plate has a polarizing layer, and a support layer that is disposed on the polarizing layer close to the optical element so as to support the polarizing layer, and
a cured coating layer formed at a surface of the polarizing plate facing the optical element.

2. The projector according to claim 1,
the optical element is a light-transmissive substrate, a cross dichroic prism, a polarization separating prism, or a lens.

3. The projector according to claim 1, further comprising:
an additional optical element disposed at an opposite side of the polarizing plate from the optical element and bonded to the polarizing plate through an adhesive layer.

4. The projector according to claim 3,
the additional optical element is a light-transmissive substrate.

5. The projector according to claim 3, further comprising:
a cured coating layer formed at a surface of the polarizing plate facing the additional optical element,
the polarizing plate further having an additional support layer that is disposed on the polarizing layer close to the additional optical element so as to support the polarizing layer.

6. The projector according to claim 1,
the adhesive layer formed of an acryl-based adhesive, a silicon-based adhesive, or an epoxy-based adhesive.

7. The projector according to claim 1,
the cured coating layer formed of acryl-based resin, silicon-based resin, melamine-based resin, urethane-based resin, or epoxy-based resin.

8. A projector comprising:
an optical element;
a viewing angle compensating plate that is attached to the optical element through a adhesive layer; and
a cured coating layer formed at a surface of the viewing angle compensating plate facing the optical element.

9. The projector according to claim 8,
the optical element is a light-transmissive substrate, a cross dichroic prism, or a lens.

10. The projector according to claim 8,
the adhesive layer formed of an acryl-based adhesive, a silicon-based adhesive, or an epoxy-based adhesive.

11. The projector according to claim 8,
the cured coating layer formed of acryl-based resin, silicon-based resin, melamine-based resin, urethane-based resin, or epoxy-based resin.

12. A projector comprising:
an optical element;
a phase plate that is attached to the optical element through a adhesive layer; and
a cured coating layer formed at a surface of the phase plate facing the optical element.

13. The projector according to claim 12,
the optical element is a polarization separating prism in a polarization conversion element, a light-transmissive substrate, or a lens.

14. The projector according to claim 12,
the adhesive layer formed of an acryl-based adhesive, a silicon-based adhesive, or an epoxy-based adhesive.

15. The projector according to claim 12,
the cured coating layer formed of acryl-based resin, silicon-based resin, melamine-based resin, urethane-based resin, or epoxy-based resin.
